(19) United States
(12) Patent Application Publication
(10) Pub. No.: US 2022/0405847 A1
(43) Pub. Date: Dec. 22, 2022

(54) SERVER FOR PROCESSING REAL ESTATE INVESTMENT MEDIATION BASED ON SECURITY TOKEN AND OPERATION METHOD THEREFOR

(71) Applicant: HDAC TECHNOLOGY AG, Steihaousen (CH)

(72) Inventor: Dae Sun CHUNG, Seoul (KR)

(73) Assignee: HDAC TECHNOLOGY AG, Steinhausen (CH)

(21) Appl. No.: 17/774,847

(22) PCT Filed: Aug. 13, 2020
(86) PCT No.: PCT/KR2020/010817

§ 371 Date: May 5, 2022

(30) Foreign Application Priority Data
Nov. 22, 2019 (KR) 10-2019-0151029

(51) Int. Cl. G06Q 40/06; G06Q 50/16; G06Q 40/04

(52) U.S. Cl. CPC G06Q 40/06; G06Q 50/16; G06Q 40/04

(57) ABSTRACT

Disclosed is a server for processing real estate investment mediation based on security token and an operation method therefor. In the server for processing real estate investment mediation and the operation method therefor according to the present invention, when information on a desired purchase quantity is received from a user terminal of any one real estate investor in addition to a purchase request signal for a specific security token issued by any one real estate investment execution company, authentication for the use terminal is completed, and then purchase processing for the specific security token is performed in response the purchase request signal to support a real estate investor to easily purchase a security token issued by the real estate investment execution company through online.

### TECHNICAL FIELD

The present invention relates to a server for processing real estate investment mediation based on a security token and an operation method therefor.

### BACKGROUND ART

After initial coin offering (ICO) through a utility token attract a public attention with the boom of cryptocurrency, security token offering (STO) through a security token has drawn the public attention in recent years.

An existing blockchain enterprise secured funds by issuing a utility token in order to collect funds to develop a project afterwards while planning a new project.

In this regard, at one time, while a cryptocurrency price rapidly increased, an ICO financing scale was increased to an astronomical amount of money and a lot of people attracted a cryptocurrency industry.

However, in an environment in which a specific regulation is not determined, some investors purchases the token at a low price in advance, and then resells the token to individuals, and there is a case where a project team completing financing escapes occurs.

In order to prevent such damage, a new alternative for financing is the STO that raises funds through the security token. The security token is a digital asset that interlocks a real asset such as real estate, intellectual property rights, etc., with the token in addition to final assets such as, stocks, bonds, etc., and an advantage of the STO is to protect procedure simplification, and cost reduction, and protection for investment upon raising the funds.

In particular, even among various real assets, the real estate attracts the public attention, and when the real estate is tokenized, investors can participate in investment even with a small amount of money unlike existing real estate investment products, and liquidity can be secured through a security token exchange after investment, and the investors diversely invest not one real estate but various real estate tokens to reduce an investment risk.

Accordingly, a research into a real estate investment mediation processing system supporting the investors to easily conduct real estate investment through online based on the security token is required.

Further, in that the real estate investment mediation processing system is a system that enables transaction of the assets, security is an important issue, and as a result, a research into a user authentication technology making a better step forward, which can be utilized in the real estate investment mediation processing system is also required.

### DISCLOSURE

### Technical Problem

In a server for processing real estate investment mediation and an operation method therefor according to the present invention, when information on a desired purchase amount is received from a user terminal of any one real estate investor in addition to a purchase request signal for a specific security token issued by any one real estate investment execution company, authentication for the use terminal is completed, and then purchase processing for the specific security token is performed in response the purchase request signal to support a real estate investor to easily purchase a security token issued by the real estate investment execution company through online.

### Technical Solution

A server for processing real estate investment mediation based on a security token according to an embodiment of the present invention includes: an execution company information database storing information on a plurality of real estate investment execution companies and information on a total quantity of security tokens issued by the plurality of real estate investment execution companies, respectively to correspond to each other; an investor information database storing information on a plurality of real estate investors and information on a total purchase quantity of security tokens purchased by the plurality of real estate investors, respectively to correspond to each other; and a purchase processing performing unit completing, when information on a desired purchase quantity jointly with a purchase request signal for a first security token issued by a first real estate investment execution company among the plurality of real estate investment execution companies is received from the user terminal of the first real estate investor among the plurality of real estate investors, authentication for the user terminal, and then decreasing a total quantity of the first security tokens stored to correspond to the information on the first real estate investment execution company in the execution company information database in response to the purchase request signal by the desired purchase quantity, and increasing the total purchase quantity of the first security tokens from a total purchase quantity of security tokens stored to correspond to the information on the first real estate investor in the investor information database by the desired purchased quantity to perform purchase processing for the first security token.

Further, an operation method of a server for processing real estate investment mediation based on a security token according to an embodiment of the present invention includes: holding an execution company information database storing information on a plurality of real estate investment execution companies and information on a total quantity of security tokens issued by the plurality of real estate investment execution companies, respectively to correspond to each other; holding an investor information database storing information on a plurality of real estate investors and information on a total purchase quantity of security tokens purchased by the plurality of real estate investors, respectively to correspond to each other; and completing, when information on a desired purchase quantity jointly with a purchase request signal for a first security token issued by a first real estate investment execution company among the plurality of real estate investment execution companies is received from the user terminal of the first real estate investor among the plurality of real estate investors, authentication for the user terminal, and then decreasing a total quantity of the first security tokens stored to correspond to the information on the first real estate investment execution company in the execution company information database in response to the purchase request signal by the desired purchase quantity, and increasing the total purchase quantity of the first security tokens from a total purchase quantity of security tokens stored to correspond to the information on the first real estate investor in the investor information database by the desired purchased quantity to perform purchase processing for the first security token.

### Advantageous Effects

In a server for processing real estate investment mediation and an operation method therefor according to the present invention, when information on a desired purchase amount is received from a user terminal of any one real estate investor in addition to a purchase request signal for a specific security token issued by any one real estate investment execution company, authentication for the use terminal is completed, and then purchase processing for the specific security token is performed in response the purchase request signal to support a real estate investor to easily purchase a security token issued by the real estate investment execution company through online.

### DESCRIPTION OF DRAWINGS

FIG. 1 is a diagram illustrating a structure of a server for processing real estate investment mediation based on a security token according to an embodiment of the present invention.

FIG. 2 is a flowchart illustrating an operation method for a server for processing real estate investment mediation based on a security token according to an embodiment of the present invention.

### MODE FOR INVENTION

Hereinafter, embodiments of the present invention will be described in detail with reference to the accompanying drawings. The description does not limit the present invention to specific embodiments, and it should be understood that the present invention covers all the modifications, equivalents and replacements included within the idea and technical scope of the present invention. In describing each drawing, like reference numerals refer to like elements and if not contrarily defined, all terms used herein including technological or scientific terms have the same meanings as those generally understood by a person with ordinary skill in the art.

In this document, unless explicitly described to the contrary, the word “comprise” and variations such as “comprises” or “comprising”, will be understood to imply the inclusion of stated elements but not the exclusion of any other elements. Further, in various exemplary embodiments of the present invention, each of components, functional blocks or means may be constituted by one or more lower components and electrical, electronic, and mechanical functions performed by respective components may be implemented as various known devices or mechanical elements including an electronic circuit, an integrated circuit, an Application Specific Integrated Circuit (ASIC), etc., and the respective components may be separately implemented or two or more components may be integrated into one and implemented.

Meanwhile, blocks of the accompanying block diagram or steps of a flowchart may be appreciated as meaning compute program instructions mounted on a processor or a memory of data processible equipment such as a universal computer, a special computer, a portable notebook computer, a network computer, etc., and performing designated functions. Since the computer program instructions may be stored in a memory provided in a computer device or a computer readable memory, functions described in blocks of a block diagram or steps of a flowchart may be produced as a manufactured object including an instruction mean performing the functions. Moreover, each block or each step may represent a part of a module, a segment, or a code that includes one or more executable instructions for executing a specified logical function(s). It should also be noted that in some replaceable embodiments, the functions mentioned in the blocks or steps may also be executed differently from a predetermined order. For example, two blocks or steps that are subsequently illustrated are substantially simultaneously carried out, or may be performed in a reverse order, and in some cases, the functions may be performed while some blocks or steps are omitted.

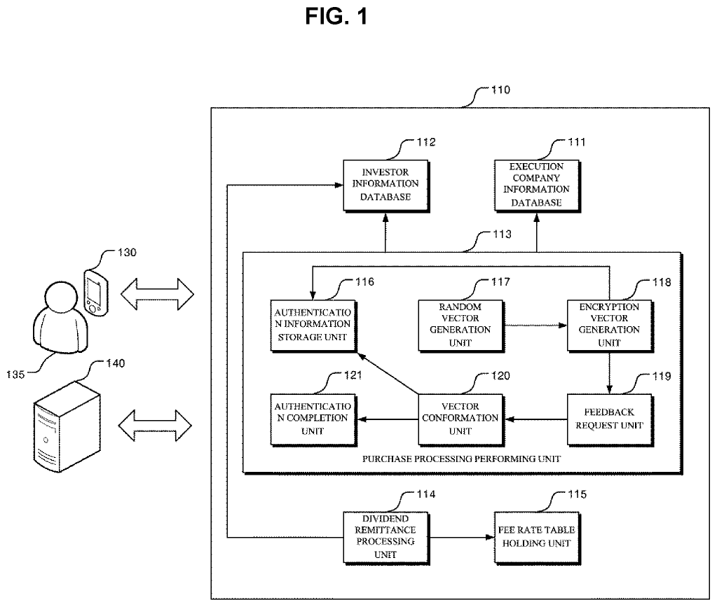

FIG. 1 is a diagram illustrating a structure of a server for processing real estate investment mediation based on a security token according to an embodiment of the present invention.

Referring to FIG. 1, the server 110 for processing real estate investment mediation based on a security token according to the present invention includes an execution company information database 111, an investor information database 112, and a purchase processing performing unit 113.

First, the server 110 for processing real estate investment mediation based on a security token according to the present invention may be utilized for a business model for collecting a predetermined fund money from real estate investors in order to secure project development cost (all cost including land purchase fee, licensing cost, construction cost, etc.) when a predetermined execution company intends to conduct a real estate development project. Specifically, a real estate investment (development) execution company issues a security token for cost required for the real estate development project and sells the issued security token to the real estate investors while starting a new real estate development project to secure a purchase price for the security token as project development cost, and distributes buildings while conducting the real estate development project by using the corresponding purchase price and completes the buildings to terminate the real estate development project, and then pay remaining real estate development execution profits to the real estate investors as to dividends. In this case, the server 110 for processing real estate investment mediation based on a security token according to the present invention as a server which may be operated in a predetermined exchange may be utilized for transaction of the security token and dividend payment processing mediation between the real estate investment execution companies and the real estate investors. In this regard, each structure of the server 110 for processing real estate investment mediation based on a security token according to the present invention is described as below.

In the execution company information database 111, information on a plurality of real estate investment execution companies and information on a total quantity of security tokens issued by the plurality of real estate investment execution companies, respectively are stored to correspond to each other.

Here, the security token means a digital asset in which real assets such as stocks, bonds, real estates, etc., are fixed to blockchain based cryptocurrencies.

In this regard, information as shown in Table 1 below may be stored in the execution company information database 111.

TABLE 1

| | |
|---|---|
| Real estate investment | |
| execution companies | Total quantity of security tokens |

| | | |
|---|---|---|
| Real estate investment | Security token 1 | 450,000,000 |
| execution company 1 | | |
| Real estate investment | Security token 2 | 380,000,000 |
| execution company 2 | | |
| Real estate investment | Security token 3 | 295,000,000 |
| execution company 3 | | |
| . . . | . . . | . . . |

In the investor information database 112, information on a plurality of real estate investors and information on a total purchase quantity of security tokens issued by the plurality of real estate investors, respectively are stored to correspond to each other.

For example, information as shown in Table 2 below may be stored in the investor information database 112.

TABLE 2

| | |
|---|---|
| | total purchase quantity |
| Real estate investors | of security tokens |

| | | |
|---|---|---|
| Real estate investor 1 | Security token 1 | 350,000 |
| | Security token 2 | — |
| | Security token 3 | 77,000 |
| | . . . | . . . |
| Real estate investor 2 | Security token 1 | 150,000 |
| | Security token 2 | 100,000 |
| | Security token 3 | 190,000 |
| | . . . | . . . |
| Real estate investor 3 | Security token 1 | 100,000 |
| | Security token 2 | 80,000 |
| | Security token 3 | 95,000 |
| | . . . | . . . |
| . . . | . . . | . . . |

When the purchase processing performing unit 113 receives information on a desired purchase quantity jointly with a purchase request signal for a first security token issued by a first real estate investment execution company among the plurality of real estate investment execution companies from a user terminal 130 of a first real estate investor 135 among the plurality of real estate investors, the purchase processing performing unit 113 completes authentication for the user terminal 130, and then decreases a total quantity of the first security tokens stored to correspond to the information on the first real estate investment execution company in the execution company information database 111 in response to the purchase request signal by the desired purchase quantity, and increases the total purchase quantity of the first security tokens from a total purchase quantity of security tokens stored to correspond to the information on the first real estate investor 135 in the investor information database 112 by the desired purchase quantity to perform purchase processing for the first security token.

For example, it is assumed that the first real estate investor 135 is ‘real estate investor 1’, the first real estate investment execution company is ‘real estate investment execution company 1’, the first security token is ‘security token 1’, and the desired purchase quantity is ‘50,000’. In this case, when information on ‘50,000’ which is the desired purchase quantity is received from the user terminal 130 of ‘real estate investor 1’ which is the first real estate investor 135 among the plurality of real estate investors by the real estate investment mediation processing server 110 jointly with the purchase request signal for ‘security token 1’ which is the first security token issued by ‘real estate investment execution company 1’ which is the first real estate investment execution company among the plurality of real estate investors, the purchase processing performing unit 113 completes the authentication for the user terminal 130, and then decreases ‘450,000,000’ which is a total quantity of ‘security token 1’ which is the first security token stored to correspond to information on ‘real estate investment execution company 1 which is the first real estate investment execution company in the execution company information database 111 shown in Table 1 above in response to the purchase request signal by ‘50,000’ which is the desired purchase quantity and increases ‘350,000’ which is a total purchase quantity of ‘security token 1’ which is the first security token from the total purchase quantity of the security tokens stored to correspond to the information on ‘real estate investor 1’ which is the first real estate investor 135 in the investor information database 112 shown in Table 2 above by ‘50,000’ which is the desired purchase quantity to perform the purchase processing for ‘security token 1’ which is the first security token.

That is, when the real estate investment mediation processing server 110 receives information on a desired purchase quantity from the user terminal 130 of a first real estate investor 135 among the plurality of real estate investors jointly with a purchase request signal for a first security token issued by a first real estate investment execution company among the plurality of real estate investment execution companies while storing information on a plurality of real estate investment execution companies and information on a total quantity of security tokens issued by the plurality of real estate investment execution companies, respectively in the execution company information database 111 and stores information on a plurality of real estate investors and information on a total purchase quantity of security tokens purchased by the plurality of real estate investors, respectively in the investor information database 112, the real estate investment mediation processing server 110 completes the authentication for the user terminal 130, and then decreases a total quantity of the first security tokens stored to correspond to the information on the first real estate investment execution company in the execution company information database 111 in response to the purchase request signal by the desired purchase quantity, and increases the total purchase quantity of the first security tokens from a total purchase quantity of security tokens stored to correspond to the information on the first real estate investor 135 by the desired purchase quantity in the investor information database 112 to perform the purchase processing for the first security token.

According to an embodiment of the present invention, account information of each real estate investor may be additionally stored to correspond to each of the information on the plurality of real estate investors in the investor information database 112.

In this regard, information as shown in Table 3 below may be additionally stored in the investor information database 112.

TABLE 3

| | Account | Total purchase quantity | |
|---|---|---|---|
| Real estate investors | information | of security tokens | |
| Real estate investor 1 | Account | Security token 1 | 350,000 |
| | information 1 | Security token 2 | — |
| | | Security token 3 | 77,000 |
| | | . . . | . . . |
| Real estate investor 2 | Account | Security token 1 | 150,000 |
| | information 2 | Security token 2 | 100,000 |
| | | Security token 3 | 190,000 |
| | | . . . | . . . |
| Real estate investor 3 | Account | Security token 1 | 100,000 |
| | information 3 | Security token 2 | 80,000 |
| | | Security token 3 | 95,000 |
| | | . . . | . . . |
| . . . | . . . | . . . | . . . |

In this case, the server 110 for processing real estate investment mediation based on a security token may further include a dividend remittance processing unit 114.

When the dividend remittance processing unit 114 receives information on a dividend amount of money which should be paid to each of at least one real estate investor from a server 140 of the second real estate investment execution company among the plurality of real estate investment execution companies jointly with a dividend payment request for at least one real estate investor purchasing a second security token issued by a second real estate investment execution company, the dividend remittance processing unit 114 confirms the account information of each of at least one real estate investor from the investor information database 112 in response to the dividend payment request, and then remits an amount of money according to a dividend amount of money which should be paid to each real estate investor for an account of each of at least one real estate investor.

For example, it is assumed that a second real estate investment execution company is ‘real estate investment execution company 2’, a second security token is ‘security token 2’, at least one real estate investor purchasing ‘security token 2’ is ‘real estate investor 2, real estate investor 3’, and each dividend amount of money is ‘52,500,000 won, ‘42,000,000 won’. In this case, when the real estate investment mediation processing server 110 receives information on ‘52,500,000 won’ and ‘42,000,000 won’ which the dividend amounts of money which should be paid to ‘real estate investor 2 and real estate investor 3’ which are at least one real estate investor, respectively from the server 140 of the second real estate investment execution company among the plurality of real estate investment execution companies jointly with a dividend payment request for ‘real estate investor 2, real estate investor 3’ which is at least one real estate investor purchasing ‘security token 2’ which is the second security token issued by ‘real estate investment execution company 2’ which is the second real estate investment execution company, the dividend remittance processing unit 114 may confirm ‘account information 2’ and ‘account information 3’ which are account information of ‘real estate investor 2 and real estate investor 3’ which are at least one real estate investor, respectively from the investor information database 112 shown in Table 3 above in response to the dividend payment request, and then remit amounts of money according to ‘52,500,000 won’ and ‘42,000,000 won’ which the dividend amounts of money which should be paid to ‘real estate investor 2 and real estate investor 3’ which are the respective real estate investors for accounts of ‘real estate investor 2 and real estate investor 3’ which are at least one real estate investor, respectively.

According to an embodiment of the present invention, the server 110 for processing real estate investment mediation based on a security token may further include a fee rate table holding unit 115.

The fee rate table holding unit 115 stores and holds a fee rate table having a fee rate corresponding to each of a plurality of predetermined member ratings recorded therein.

For example, the fee rate table may be shown as in Table 4 below.

TABLE 4

| Member ratings | Fee rate |
|---|---|
| Rating 1 | 0.1% |
| Rating 2 | 0.2% |
| Rating 3 | 0.3% |
| Rating 4 | 0.4% |
| Rating 5 | 0.5% |

In this case, a predetermined member rating of each real estate investor may be additionally stored to correspond to information on each of the plurality of real estate investors in the investor information database 112.

In this regard, information as shown in Table 5 below may be additionally stored in the investor information database 112.

TABLE 5

| Real estate | Member | Account | Total purchase quantity | |
|---|---|---|---|---|
| investors | ratings | information | of security tokens | |
| Real estate | Rating 2 | Account | Security token 1 | 350,000 |
| investor 1 | | information 1 | Security token 2 | — |
| | | | Security token 3 | 77,000 |
| | | | . . . | . . . |
| Real estate | Rating 1 | Account | Security token 1 | 150,000 |
| investor 2 | | information 2 | Security token 2 | 100,000 |
| | | | Security token 3 | 190,000 |
| | | | . . . | . . . |
| Real estate | Rating 3 | Account | Security token 1 | 100,000 |
| investor 3 | | information 3 | Security token 2 | 80,000 |
| | | | Security token 3 | 95,000 |
| | | | . . . | . . . |
| . . . | . . . | . . . | . . . | . . . |

In this case, the dividend remittance processing unit 114 may confirm the account information and the member rating of each of at least one real estate investor from the investor information database 112 in response to the dividend payment request, confirm the fee rate for the member rating of each of at least one real estate investor by referring to the fee rate table, and then remit an amount of money acquired by subtracting the fee according to the fee rate for the member rating of each real estate investor from the dividend amount of money which should be paid to each real estate investor for the account of each of at least one real estate investor.

For example, as in the example described above, when it is assumed that the real estate investment mediation processing server 110 receives information on ‘52,500,000 won’ and ‘42,000,000 won’ which the dividend amounts of money which should be paid to ‘real estate investor 2 and real estate investor 3’ which are at least one real estate investor, respectively from the server 140 of the second real estate investment execution company among the plurality of real estate investment execution companies jointly with a dividend payment request for ‘real estate investor 2, real estate investor 3’ which is at least one real estate investor purchasing ‘security token 2’ which is the second security token issued by ‘real estate investment execution company 2’ which is the second real estate investment execution company, the dividend remittance processing unit 114 may confirm ‘account information 2’ and ‘account information 3’ which are account information of ‘real estate investor 2 and real estate investor 3’ which are at least one real estate investor, respectively and ‘rating 1’ and ‘rating 3’ which are the member ratings from the investor information database 112 shown in Table 5 above in response to the dividend payment request, confirm ‘0.1%’ and ‘0.3%’ which are the fee rates for ‘rating 1’ and ‘rating 3’ which are the member ratings of ‘real estate investor 2, real estate investor 3’ which are at least one real estate investor by referring to the fee rate table shown in Table 4 above, and then remit ‘52,447,500’ and ‘41,874,000’ which are amounts of money acquired by subtracting ‘52,500 won’ and ‘126,000 won’ which are fees according to ‘0.1%’ and ‘0.3%’ which are the fee rates for ‘rating 1’ and ‘rating 3’ which are the member ratings of ‘real estate investor 2’ and ‘real estate investor 3’ which are the respective real estate investors from ‘52,500,000 won’ and ‘42,000,000 won’ which are the dividend amounts of money which should be paid to ‘real estate investor 2’ and ‘real estate investor 3’ which are the respective real estate investors for the accounts of ‘real estate investor 2 and real estate investor 3’ which are at least one real estate investor.

According to an embodiment of the present invention, the purchase processing performing unit 113 as a component for authenticating a terminal before performing purchase processing for the security token may include an authentication information storage unit 116, a random vector generation unit 117, an encryption vector generation unit 118, a feedback request unit 119, a vector confirmation unit 120, and an authentication completion unit 121.

The authentication information storage unit 116 stores a generator matrix having a predetermined k×n (k and n are natural numbers of 2 or more and n is a number larger than k) size having an error correction capability for a code of t (t is a natural number) bits used for terminal authentication, and a predetermined n-dimensional authentication vector.

The generator matrix is a matrix used for generating a codeword so as for a data receiving side to perform error correction when a data transmitting side transmits data to the data receiving side, and when the data transmitting side generates the codeword based on a predetermined generator matrix and transmits the generated codeword to the data receiving side, the data receiving side may restore an error and original data from data received through a parity check matrix corresponding to the generator matrix.

When the random vector generation unit 117 receives information on a desired purchase quantity from the user terminal 130 jointly with the purchase request signal for the first security token issued by the first real estate investment execution company, the random vector generation unit 117 randomly generates a k-dimensional first random vector and randomly generates an n-dimensional second random vector in which a Hamming weight is t.

Here, the Hamming weight means the number of code values, which is ‘1’ in a set of code values constituted by ‘0’ and ‘1’.

The encryption vector generation unit 118 performs encoding for the first random vector based on the generator matrix to generate a first codeword for the first random vector and applies the second random vector to the first codeword as an error code to generate an n-dimensional first encryption vector.

For example, when the generator matrix is ‘G’, the first random vector is ‘m’, and the second random vector is ‘e’, the encryption vector generation unit 118 may generate the first encryption vector ‘r’ according to an operation of Equation 1 below.

r=mG⊕e [Equation 1]

Here, ⊕ means an exclusive OR operation. G may be a matrix having a k×n size, m as a k-dimensional vector may be expressed as a row vector having a 1×k size, and e is an n-dimensional vector, and as a result, the first encryption vector becomes an n-dimensional vector.

While the feedback request unit 119 transmits the first encryption vector to the user terminal 130, the feedback request unit 119 requests transmission of a feedback vector corresponding to the first encryption vector to the user terminal 130.

In this case, according to an embodiment of the present invention, when the user terminal 130 stores a parity check matrix having an (n−k)×n size corresponding to the generator matrix and the authentication vector in a memory in advance, and receives the first encryption vector and a transmission request of the feedback vector corresponding to the first encryption vector from the real estate investment mediation processing server 110, the user terminal 130 performs error correction based decoding for the first encryption vector based on the parity check matrix stored in the memory to restore the second random vector inserted as the error code from the first encryption vector and computes a Hadamard product between the restored second random vector and the authentication vector stored in the memory to generate a first feedback vector, and then transmit the first feedback vector to the real estate investment mediation processing server 110.

In this regard, when the first encryption vector is ‘r’ expressed in Equation 1 above and the parity check matrix is ‘H’, an operation of the user terminal 130 is described as below.

First, the parity check matrix is a matrix for verifying whether an error occurs in the data received by the data receiving side when the data transmitting side transmits the codeword encoded based on the predetermined generator matrix to the data receiving side, and the parity check matrix H corresponding to the generator matrix G having the k×n size has characteristics shown in Equation 2 below in a relationship with the generator matrix G.

GH^{T}=0 [Equation 2]

Here, H^{T} means a transposed matrix of the parity check matrix.

In this case, when the user terminal 130 receives the first encryption vector r from the real estate investment mediation processing server 110, the user terminal 130 may perform an operation according to Equation 3 below based on the first encryption vector r and the parity check matrix H stored in the memory.

rH^{T}=S [Equation 3]

As in Equation 3 above, S calculated by multiplying the first encryption vector r and the transposed matrix H^{T} of the parity check matrix is referred to as a syndrome. The syndrome S calculated according to Equation 3 above may be expressed as a row vector having a 1×(n−k) size because the first encryption vector is the n-dimensional vector and the parity check matrix has the (n−k)×n size.

In this case, since r=mG⊕e, rH^{T} may be expressed as in Equation 4 below due to the characteristics shown in Equation 2 above.

$$r {H}^{T} = ( mG ⊕ e ) {H}^{T} = {mG H}^{T} ⊕ {eH}^{T} = {eH}^{T} \qquad [ Equation 4 ]$$

In this case, when the syndrome S is computed according to the operation of Equation 3 above, the user terminal 130 may find the second random vector e satisfying eH^{T}=S by using the characteristics of Equation 4 above.

The second random vector e is a vector which exists as the error code within the first encryption vector r as shown in Equation 1 above and the Hamming weight is t, and as a result, the first encryption vector r may be regarded as a vector in which the error occurs only for the t-bit code in the first codeword called mG.

Accordingly, since the parity check matrix H is a matrix corresponding to the generator matrix G having the error correction capability for the t-bit code, the user terminal 130 performs syndrome decoding for finding e satisfying eH^{T}=S to restore the second random vector e inserted as the error code from the first encryption vector r.

As such, when the second random vector e is restored, the user terminal 130 may generate a first feedback vector by computing the Hadamard product between the restored second random vector and the authentication vector stored in the memory, and then transmit the first feedback vector to the real estate investment mediation processing server 110.

Here, the Hadamard product means an operation of multiplying respective components in vectors or matrices having the same size, and when vectors [a b c] and [x y z] exist, the Hadamard product between both vectors may be computed as [ax by cz].

When the vector confirmation unit 120 receives, from the user terminal 130, the first feedback vector (the first feedback vector is a vector generated when the error correction based decoding for the first encryption vector is performed based on the parity check matrix having the (n−k)×n size, which corresponds to the generator matrix, and the second random vector is restored, and then the Hadamard product between the restored second random vector and the authentication vector prestored in the user terminal 130 is computed) as the feedback vector corresponding to the first encryption vector, the vector confirmation unit 120 generates a first computed vector by computing the Hadamard product between the second random vector and the authentication vector, and confirms whether the first computed vector is the same as the first feedback vector.

Here, since a meaning that the first computed vector and the first feedback vector are the same as each other is a meaning that the first feedback vector is received from a terminal which possesses an authentication vector which is the same as the authentication vector stored in the authentication information storage unit 116, when the first computed vector and the first feedback vector are the same as each other, it may be regarded that the user terminal 130 is a terminal possessed by an authenticated user.

When the authentication completion unit 121 confirms that the first computed vector and the first feedback vector are the same as each other, the authentication completion unit 121 completes terminal authentication for the user terminal 130.

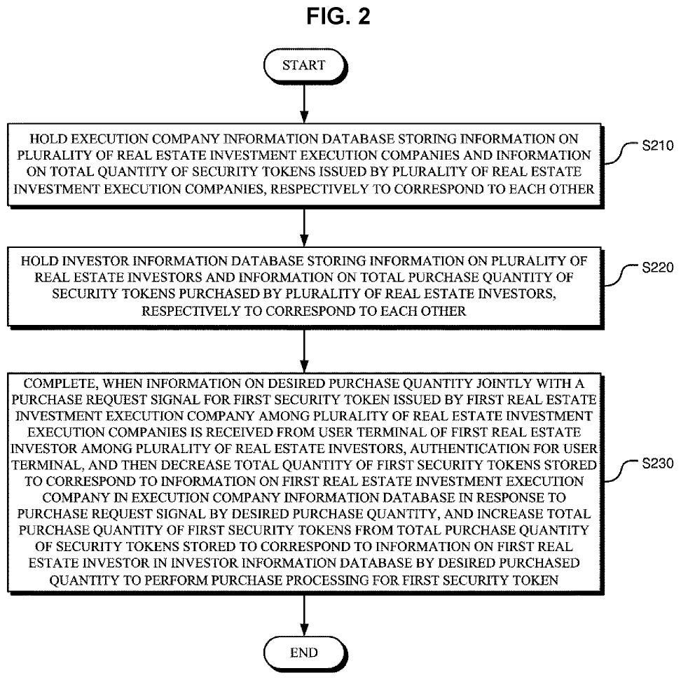

FIG. 2 is a flowchart illustrating an operation method for a server for processing real estate investment mediation based on a security token according to an embodiment of the present invention.

In step (S210), the execution company information database is held, which stores information on a plurality of real estate investment execution companies and information on a total quantity of security tokens issued by the plurality of real estate investment execution companies, respectively to correspond to each other.

In step (S220), the investor information database is held, which stores information on a plurality of real estate investors and information on a total purchase quantity of security tokens purchased by the plurality of real estate investors, respectively to correspond to each other.

In step (S230), when information on a desired purchase quantity jointly with a purchase request signal for a first security token issued by a first real estate investment execution company among the plurality of real estate investment execution companies is received from the user terminal of the first real estate investor among the plurality of real estate investors, authentication for the user terminal is completed, and then a total quantity of the first security tokens stored to correspond to the information on the first real estate investment execution company in the execution company information database in response to the purchase request signal is decreased by the desired purchase quantity, and the total purchase quantity of the first security tokens from a total purchase quantity of security tokens stored to correspond to the information on the first real estate investor in the investor information database is increased by the desired purchased quantity to perform purchase processing for the first security token.

In this case according to an embodiment of the present invention, account information of each real estate investor may be additionally stored to correspond to each of the information on the plurality of real estate investors in the investor information database.

In this case, the operation method of the server for processing real estate investment mediation based on a security token may further include a step in which when information on a dividend amount of money which should be paid to each of at least one real estate investor is received from the server of the second real estate investment execution company among the plurality of real estate investment execution companies jointly with a dividend payment request for at least one real estate investor purchasing a second security token issued by a second real estate investment execution company, the account information of each of at least one real estate investor is confirmed from the investor information database in response to the dividend payment request, and then an amount of money according to a dividend amount of money which should be paid to each real estate investor is remitted for an account of each of at least one real estate investor.

In this case, according to an embodiment of the present invention, the operation method of the server for processing real estate investment mediation based on a security token may further include a step of storing and holding a fee rate table having a fee rate corresponding to each of a plurality of predetermined member ratings recorded therein.

In this case, a predetermined member rating of each real estate investor may be additionally stored to correspond to information on each of the plurality of real estate investors in the investor information database.

In this case, in the step of remitting the amount of money according to the dividend amount of money, the account information and the member rating of each of at least one real estate investor may be confirmed from the investor information database in response to the dividend payment request, the fee rate for the member rating of each of at least one real estate investor may be confirmed by referring to the fee rate table, and then an amount of money acquired by subtracting the fee according to the fee rate for the member rating of each real estate investor from the dividend amount of money which should be paid to each real estate investor may be remitted for the account of each of at least one real estate investor.

Further, according to an embodiment of the present invention, step (S230) may include a step of holding an authentication information storage unit storing a generator matrix having a predetermined k×n (k and n are natural numbers of 2 or more and n is a number larger than k) size having an error correction capability for a code of t (t is a natural number) bits used for terminal authentication, and a predetermined n-dimensional authentication vector, a step of randomly generating a k-dimensional first random vector and randomly generating an n-dimensional second random vector in which a Hamming weight is t when information on a desired purchase quantity is received from the user terminal jointly with the purchase request signal for the first security token issued by the first real estate investment execution company, a step of performing encoding for the first random vector based on the generator matrix to generate a first codeword for the first random vector and applying the second random vector to the first codeword as an error code to generate an n-dimensional first encryption vector, a step of requesting transmission of a feedback vector corresponding to the first encryption vector to the user terminal while transmitting the first encryption vector to the user terminal, a step of generating a first computed vector by computing the Hadamard product between the second random vector and the authentication vector, and confirming whether the first computed vector is the same as the first feedback vector when the first feedback vector (the first feedback vector is a vector generated when the error correction based decoding for the first encryption vector is performed based on the parity check matrix having the (n−k)×n size, which corresponds to the generator matrix, and the second random vector is restored, and then the Hadamard product between the restored second random vector and the authentication vector prestored in the user terminal is computed) is received from the user terminal as the feedback vector corresponding to the first encryption vector, and a step of completing terminal authentication for the user terminal when it is confirmed that the first computed vector and the first feedback vector are the same as each other.

In this case, according to an embodiment of the present invention, when the user terminal stores a parity check matrix having an (n−k)×n size corresponding to the generator matrix and the authentication vector in a memory in advance, and receives the first encryption vector and a transmission request of the feedback vector corresponding to the first encryption vector from the real estate investment mediation processing server, the user terminal performs error correction based decoding for the first encryption vector based on the parity check matrix stored in the memory to restore the second random vector inserted as the error code from the first encryption vector and computes a Hadamard product between the restored second random vector and the authentication vector stored in the memory to generate a first feedback vector, and then transmit the first feedback vector to the real estate investment mediation processing server.

Hereinabove, the operation method for a server for processing real estate investment mediation based on a security token according to an embodiment of the present invention is described with reference to FIG. 2. Here, since the operation method for a server for processing real estate investment mediation based on a security token according to an embodiment of the present invention may correspond to the configuration for the operation of the server 110 for processing real estate investment mediation based on a security token described by using FIG. 1, a more detailed description thereof will be omitted.

The operation method of the server for processing real estate investment mediation based on a security token according to an embodiment of the present invention may be implemented by a computer program stored in a storage medium for executing the computer program through coupling with a computer.

Further, the operation method of the server for processing real estate investment mediation based on a security token according to an embodiment of the present invention may be implemented in a program command type which may be performed through various computer means and recorded in a computer readable medium. The computer readable medium may include a program command, a data file, a data structure, etc., singly or combinationally. The program command recorded in the medium may be specially designed and configured for the present invention, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler.

As described above, the present invention has been described by specified matters such as detailed components, and the like and limited exemplary embodiments and drawings, but the description is just provided to assist more overall understanding of the present invention and the present invention is not limited to the exemplary embodiment and various modifications and changes can be made by those skilled in the art from such a disclosure.

Accordingly, the spirit of the present invention should not be defined only by the described exemplary embodiments, and it should be appreciated that claims to be described below and all things which are equivalent to the claims or equivalently modified to the claims are included in the scope of the spirit of the present invention.

1. A server for processing real estate investment mediation based on a security token, the server comprising:
an execution company information database storing information on a plurality of real estate investment execution companies and information on a total quantity of security tokens issued by the plurality of real estate investment execution companies, respectively to correspond to each other;
an investor information database storing information on a plurality of real estate investors and information on a total purchase quantity of security tokens purchased by the plurality of real estate investors, respectively to correspond to each other; and
a purchase processing performing unit completing, when information on a desired purchase quantity jointly with a purchase request signal for a first security token issued by a first real estate investment execution company among the plurality of real estate investment execution companies is received from the user terminal of the first real estate investor among the plurality of real estate investors, authentication for the user terminal, and then decreasing a total quantity of the first security tokens stored to correspond to the information on the first real estate investment execution company in the execution company information database in response to the purchase request signal by the desired purchase quantity, and increasing the total purchase quantity of the first security tokens from a total purchase quantity of security tokens stored to correspond to the information on the first real estate investor in the investor information database by the desired purchased quantity to perform purchase processing for the first security token.

2. The server for processing real estate investment mediation based on a security token of claim 1, wherein account information of each real estate investor is additionally stored to correspond to information on each of the plurality of real estate investors in the investor information database, and
the server for processing real estate investment mediation based on a security token further includes
when a dividend remittance processing unit receives information on a dividend amount of money which should be paid to each of at least one real estate investor from a server of the second real estate investment execution company among the plurality of real estate investment execution companies jointly with a dividend payment request for at least one real estate investor purchasing a second security token issued by a second real estate investment execution company, the dividend remittance processing unit confirming the account information of each of at least one real estate investor from the investor information database in response to the dividend payment request, and then remitting an amount of money according to a dividend amount of money which should be paid to each real estate investor for an account of each of at least one real estate investor.

3. The server for processing real estate investment mediation based on a security token of claim 2, further comprising:
a fee rate table holding unit storing and holding a fee rate table having a fee rate corresponding to each of a plurality of predetermined member ratings recorded therein,
wherein a predetermined member rating of each real estate investor is additionally stored to correspond to information on each of the plurality of real estate investors in the investor information database, and
the dividend remittance processing unit confirms the account information and the member rating of each of at least one real estate investor from the investor information database in response to the dividend payment request, confirms the fee rate for the member rating of each of at least one real estate investor by referring to the fee rate table, and then remits an amount of money acquired by subtracting the fee according to the fee rate for the member rating of each real estate investor from the dividend amount of money which should be paid to each real estate investor for the account of each of at least one real estate investor.

4. The server for processing real estate investment mediation based on a security token of claim 1, wherein the purchase processing performing unit includes
an authentication information storage unit storing a generator matrix having a predetermined k×n (k and n are natural numbers of 2 or more and n is a number larger than k) size having an error correction capability for a code of t (t is a natural number) bits used for terminal authentication, and a predetermined n-dimensional authentication vector,
when information on a desired purchase quantity is received from the user terminal jointly with the purchase request signal for the first security token issued by the first real estate investment execution company, a random vector generation unit randomly generating a k-dimensional first random vector and randomly generating an n-dimensional second random vector in which a Hamming weight is t,
an encryption vector generation unit performing encoding for the first random vector based on the generator matrix to generate a first codeword for the first random vector and applying the second random vector to the first codeword as an error code to generate an n-dimensional first encryption vector,
a feedback request unit requesting transmission of a feedback vector corresponding to the first encryption vector to the user terminal while transmitting the first encryption vector to the user terminal,
when the first feedback vector (the first feedback vector is a vector generated when the error correction based decoding for the first encryption vector is performed based on the parity check matrix having the (n−k)×n size, which corresponds to the generator matrix, and the second random vector is restored, and then the Hadamard product between the restored second random vector and the authentication vector prestored in the user terminal is computed) is received from the user terminal as the feedback vector corresponding to the first encryption vector, a vector confirmation unit generating a first computed vector by computing the Hadamard product between the second random vector and the authentication vector, and confirming whether the first computed vector is the same as the first feedback vector, and
when it is confirmed that the first computed vector and the first feedback vector are the same as each other, an authentication completion unit completing terminal authentication for the user terminal.

5. The server for processing real estate investment mediation based on a security token of claim 4, wherein the user terminal stores a parity check matrix having an (n−k)×n size corresponding to the generator matrix and the authentication vector in a memory in advance, and
when the first encryption vector and a transmission request of the feedback vector corresponding to the first encryption vector are received from the real estate investment mediation processing server, the user terminal performs error correction based decoding for the first encryption vector based on the parity check matrix stored in the memory to restore the second random vector inserted as the error code from the first encryption vector and computes a Hadamard product between the restored second random vector and the authentication vector stored in the memory to generate a first feedback vector, and then transmit the first feedback vector to the real estate investment mediation processing server.

6. An operation method of a server for processing real estate investment mediation based on a security token, the method comprising:
holding an execution company information database storing information on a plurality of real estate investment execution companies and information on a total quantity of security tokens issued by the plurality of real estate investment execution companies, respectively to correspond to each other;
holding an investor information database storing information on a plurality of real estate investors and information on a total purchased quantity of security tokens purchased by the plurality of real estate investors, respectively to correspond to each other; and
completing, when information on a desired purchase quantity jointly with a purchase request signal for a first security token issued by a first real estate investment execution company among the plurality of real estate investment execution companies is received from the user terminal of the first real estate investor among the plurality of real estate investors, authentication for the user terminal, and then decreasing a total quantity of the first security tokens stored to correspond to the information on the first real estate investment execution company in the execution company information database in response to the purchase request signal by the desired purchase quantity, and increasing the total purchase quantity of the first security tokens from a total purchase quantity of security tokens stored to correspond to the information on the first real estate investor in the investor information database by the desired purchased quantity to perform purchase processing for the first security token.

7. The operation method of a server for processing real estate investment mediation based on a security token of claim 6, wherein account information of each real estate investor is additionally stored to correspond to information on each of the plurality of real estate investors in the investor information database, and
the operation method of a server for processing real estate investment mediation based on a security token further includes
when information on a dividend amount of money which should be paid to each of at least one real estate investor is received from a server of the second real estate investment execution company among the plurality of real estate investment execution companies jointly with a dividend payment request for at least one real estate investor purchasing a second security token issued by a second real estate investment execution company, confirming the account information of each of at least one real estate investor from the investor information database in response to the dividend payment request, and then remitting an amount of money according to a dividend amount of money which should be paid to each real estate investor for an account of each of at least one real estate investor.

8. The operation method of a server for processing real estate investment mediation based on a security token of claim 7, further comprising:
storing and holding a fee rate table having a fee rate corresponding to each of a plurality of predetermined member ratings recorded therein,
wherein a predetermined member rating of each real estate investor is additionally stored to correspond to information on each of the plurality of real estate investors in the investor information database, and
in the remitting of the amount of money according to the dividend amount of money,
the account information and the member rating of each of at least one real estate investor are confirmed from the investor information database in response to the dividend payment request, the fee rate for the member rating of each of at least one real estate investor is confirmed by referring to the fee rate table, and then an amount of money acquired by subtracting the fee according to the fee rate for the member rating of each real estate investor from the dividend amount of money which should be paid to each real estate investor is remitted for the account of each of at least one real estate investor.

9. The operation method of a server for processing real estate investment mediation based on a security token of claim 6, wherein the performing of the purchase processing includes
holding an authentication information storage unit storing a generator matrix having a predetermined k×n (k and n are natural numbers of 2 or more and n is a number larger than k) size having an error correction capability for a code of t (t is a natural number) bits used for terminal authentication, and a predetermined n-dimensional authentication vector,
when information on a desired purchase quantity is received from the user terminal jointly with the purchase request signal for the first security token issued by the first real estate investment execution company, randomly generating a k-dimensional first random vector and randomly generating an n-dimensional second random vector in which a Hamming weight is t,
performing encoding for the first random vector based on the generator matrix to generate a first codeword for the first random vector and applying the second random vector to the first codeword as an error code to generate an n-dimensional first encryption vector,
requesting transmission of a feedback vector corresponding to the first encryption vector to the user terminal while transmitting the first encryption vector to the user terminal,
when the first feedback vector, wherein the first feedback vector is a vector generated when the error correction based decoding for the first encryption vector is performed based on the parity check matrix having the (n−k)×n size, which corresponds to the generator matrix, and the second random vector is restored, and then the Hadamard product between the restored second random vector and the authentication vector prestored in the user terminal is computed, is received from the user terminal as the feedback vector corresponding to the first encryption vector, generating a first computed vector by computing the Hadamard product between the second random vector and the authentication vector, and confirming whether the first computed vector is the same as the first feedback vector, and
when it is confirmed that the first computed vector and the first feedback vector are the same as each other, completing terminal authentication for the user terminal.

10. The operation method of a server for processing real estate investment mediation based on a security token of claim 9, wherein the user terminal stores a parity check matrix having an (n−k)×n size corresponding to the generator matrix and the authentication vector in a memory in advance, and
when the first encryption vector and a transmission request of the feedback vector corresponding to the first encryption vector are received from the real estate investment mediation processing server, the user terminal performs error correction based decoding for the first encryption vector based on the parity check matrix stored in the memory to restore the second random vector inserted as the error code from the first encryption vector and computes a Hadamard product between the restored second random vector and the authentication vector stored in the memory to generate a first feedback vector, and then transmit the first feedback vector to the real estate investment mediation processing server.

11-12. (canceled)

13. A non-transitory computer readable recording medium having a program recorded therein for allowing a computer to execute an operation method of a server for processing real estate investment mediation based on a security token, the method comprising:
holding an execution company information database storing information on a plurality of real estate investment execution companies and information on a total quantity of security tokens issued by the plurality of real estate investment execution companies, respectively to correspond to each other;
holding an investor information database storing information on a plurality of real estate investors and information on a total purchased quantity of security tokens purchased by the plurality of real estate investors, respectively to correspond to each other; and
completing, when information on a desired purchase quantity jointly with a purchase request signal for a first security token issued by a first real estate investment execution company among the plurality of real estate investment execution companies is received from the user terminal of the first real estate investor among the plurality of real estate investors, authentication for the user terminal, and then decreasing a total quantity of the first security tokens stored to correspond to the information on the first real estate investment execution company in the execution company information database in response to the purchase request signal by the desired purchase quantity, and increasing the total purchase quantity of the first security tokens from a total purchase quantity of security tokens stored to correspond to the information on the first real estate investor in the investor information database by the desired purchased quantity to perform purchase processing for the first security token.
